(19) United States
(12) Patent Application Publication
(10) Pub. No.: US 2015/0048561 A1
(43) Pub. Date: Feb. 19, 2015

(54) METHOD FOR PRODUCING FLAME-RETARDANT PLASTIC WORKPIECES

(71) Applicants: Sonja Oesterle, Grunbach (DE); Dirk Schmiederer, Kornwestheim (DE); Ilonka Wachendorfer, Baltmannsweiler (DE); Jens Ackermann, Stuttgart (DE)

(72) Inventors: Sonja Oesterle, Grunbach (DE); Dirk Schmiederer, Kornwestheim (DE); Ilonka Wachendorfer, Baltmannsweiler (DE); Jens Ackermann, Stuttgart (DE)

(73) Assignee: ROBERT BOSCH GMBH, Stuttgart (DE)

(21) Appl. No.: 14/387,176

(22) PCT Filed: Feb. 15, 2013
(86) PCT No.: PCT/EP2013/053104

§ 371 Date: Sep. 22, 2014

(30) Foreign Application Priority Data
Mar. 21, 2012 (DE) 102012204486.8

(51) Int. Cl. B29C 33/56; B29C 51/00; B29C 45/00; B29C 49/00; B29C 49/04; B29C 51/26

(52) U.S. Cl. CPC B29C 33/56; B29C 49/04; B29C 51/26; B29C 45/0001; B29C 49/0005; B29C 51/002; B29K 2105/0026
USPC 264/540; 264/571; 264/328.1; 264/338

(57) ABSTRACT

A method is described for producing flame-retardant plastic workpieces, the flame retardant being applied to a material mold and being incorporated into the plastic in a targeted manner via injection molding or extrusion blow-molding.

### FIELD OF THE INVENTION

The present invention relates to the production of flame-retardant plastic workpieces.

### BACKGROUND INFORMATION

An injection molding method and an injection molding machine are described in German Patent No. 20 2007 018 370 111.

For many applications, such as household appliances or electric cars, there are increased demands on the plastic workpieces used, with regard to flame protection. Increased flame protection is usually achieved by incorporating additives in the compounds.

There is the necessity, however, for alternative methods for incorporating such additives.

### SUMMARY

Consequently, it is the object of the present invention to provide an alternative production method for producing flame-retardant plastic workpieces. The object is attained by the method according the present invention. According to that, a method is provided for producing flame-retardant plastic workpieces, including the steps:
a) (partial) impregnating of a material mold with a flame-retardant material
b) introducing flame-retardant material into the plastic workpiece during the molding of the plastic workpiece

It has turned out surprisingly that flame-retardant plastic workpieces are able to be produced in that way in a simple manner. In particular, it has turned out that the plastic workpieces thus produced frequently have one or more of the following advantages:
the flame-retardant layer is specifically present only on the surface of those areas of the plastic workpiece on which flame protection is necessary. Consequently, negative surface properties, which originate with the presence of flame-retardant materials, are able to be reduced or partially even completely avoided.
In many application of the method (see below for more on this), the plastic is present as a melt or melt-like or rather, in a softened state, so that the flame protection material is able to be embedded in the plastic, close to the surface. The result is that no, or only a few faults result by the peeling off of the flame-retardant layer, and abrasion of the flame-retardant layer occurs in delayed fashion.
The method requires no additional, subsequent steps but may be informally integrated into existing production methods.
The flame-retardant additives are present where they are effective—on the molding surface. This makes a lower additive content sufficient for the same effect. In addition, the components have better mechanical properties, since a lower concentration of filler is present over the component cross section.
Standard plastics may be processed, which are easier to process and more cost-effective, as a rule.
Since the flame-retardant additives do not have to be incorporated in the compound, additives may also be used with flame-retardant effect, which have a lower processing stability and would be disintegrated during compounding, such as expandable graphite.

By the term “plastic workpiece” one may particularly understand, within the meaning of the present invention, that a plastic is brought into a form required for a specific application in an original form method or a converting method. Suitable plastics are particularly thermoplastics, such as polyolefins, polyamides, polyesters, polyacetals and/or polyketones, but also thermosetting plastics, glass fiber composites, aramid fiber composites and/or carbon fiber composites and/or elastomers, as well as mixtures of these materials.

By the term “flame-retardant” or “flame-retarded” within the meaning of the present invention one should understand especially that, by at least one additive, there results a minimization of the risk of fire, a reduction in the probability of ignition and/or a delayed development of fire. Suitable flame-retardant materials are, for example, red phosphorus, polybrominated and/or polychlorinated organic compounds, antimony trioxide, metal hydroxides, organic phosphorus compounds, melamine cyanurate, zinc borate, expandable graphite, PTFE, aluminum oxide and/or hexagonal boron nitride or mixtures of these materials.

By the term “material mold” within the meaning of the present invention one should particularly understand a mold with the aid of which the plastic workpiece is able to be produced, formed or modified, such as an injection molding tool, an extrusion tool, a compression molding die and/or a thermoforming tool.

By the term “molding” within the meaning of the present invention one should understand particularly any production method in which a plastic workpiece is produced, formed or modified using the material mold.

According to one preferred specific embodiment of the present invention, the method according to the present invention is an injection molding method, a thermoforming method, an extrusion method or an. extrusion blow-molding method. These methods have particularly proven themselves in practice.

By the term “injection molding method” one should understand particularly that a plastic is plasticized in an assembly and cyclically introduced into a material mold that has been brought to the correct temperature.

By “thermoforming method” one should particularly understand that at least one plastic semi-finished product is converted to a plastic state and then has its geometry changed by a material mold.

By the term “extrusion blow-molding” one should particularly understand that a plastic is continuously plasticized and is cyclically transferred to a material mold where, for example, its geometry is able to be changed by an inside pressure.

According to one preferred specific embodiment of the method, step a) is carried out in such a way that a solution of the flame retardant is applied to the material mold, or specific areas of the same, and the solvent is subsequently removed.

The application may take place in an open and/or closed tool, for instance, by spraying on, brushing on and/or injecting. The removal of the solvent may be done by drying, heating, applying a vacuum and/or blowing it off.

Alternatively or in supplement, the flame retardant may also be applied in powder form, for example.

The components named above as well as the ones described in the exemplary embodiments to be used according to the present invention are not subject to exceptional conditions as to their size, design, material selection and technical conception, so that the selection criteria known in this field of application may be applied without restriction.

### BRIEF DESCRIPTION OF THE DRAWINGS

FIGS. 1 through 4 show an exemplary sequence schematic of a production process according to a first specific embodiment of the method. This method is an injection molding method, but the method is not limited to that. It should be pointed out that the method will not be described in all its particulars with respect to injection molding; however, further details are known to one skilled in the art.

### DETAILED DESCRIPTION

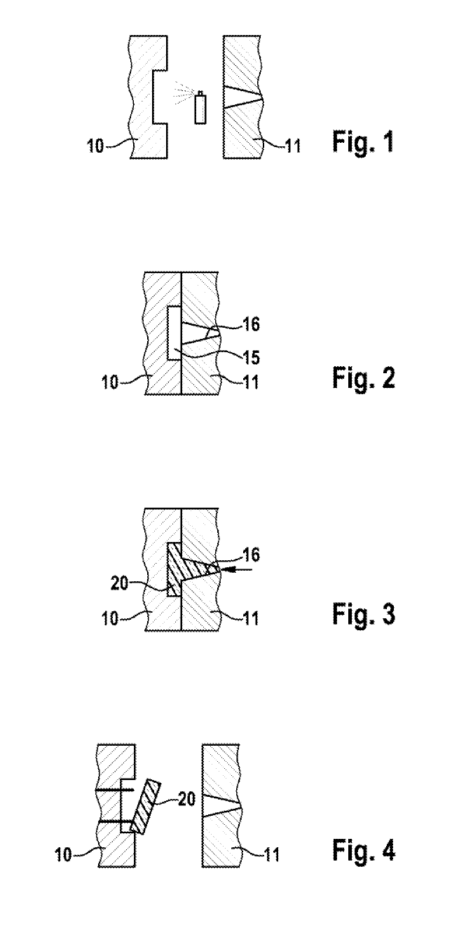

In FIG. 1, the material mold, which is made up of two parts 10 (ejector side) and 11 (die side), is first of all provided with flame retardant on ejector side 10. In this specific embodiment, this takes place, as may be seen in FIG. 1, by spraying on a solution and a subsequent drying step (not shown in the figures).

The mold is then closed (FIG. 2), whereby a cavity 15 forms, and the plastic is injected through gate 16 (FIG. 3). In the course of this production process, the flame retardant, which had been located on ejector side 10 of the material mold, is now pressed or intercalated into plastic workpiece 20 that is being created, so that a flame-retardant layer forms close to the surface in a targeted manner.

After the separation of die side 11 and ejector side 10 (FIG. 4), finished plastic workpiece 20 is able to be obtained, which is now provided with the flame retardant on the ejector side. Depending on the manner of application, the flame retardant may be applied over the whole surface or partially and molded.

The individual combinations of the components and the features of the embodiments already mentioned are examples; the exchange and the substitutions of these teachings with other teachings included in this document with the cited documents are also explicitly taken into consideration. One skilled in the art will recognize that variations modifications and other embodiments that are described in this instance may also occur without deviating from the idea of the invention and the scope of the invention. Accordingly, the above description is to be regarded as exemplary and not as limiting. The word “include” used in the claims does not exclude other components or steps. The indefinite article “a” does not exclude the meaning of a plural. The mere fact that certain measures are recited in mutually different claims does not make it clear that a combination of these measures cannot be used to advantage. The scope of the present invention is defined in the following claims and the associated equivalents.

1-8. (canceled)

9. A method for producing a flame-retardant plastic workpiece, comprising:
performing an at least partial impregnating of a material mold with a flame-retardant material; and
introducing the flame-retardant material into the plastic workpiece during a molding of the plastic workpiece.

10. The method as recited in claim 9, wherein the plastic workpiece is made of a material selected from the group including at least one of thermoplastics, thermosetting plastics, glass fiber composites, aramid fiber composites, carbon fiber composites, and elastomers.

11. The method as recited in claim 9, wherein the flame-retardant material is selected from the group including at least one of red phosphorus, polybrominated organic compounds, polychlorinated organic compounds, antimony trioxide, metal hydroxides, organic phosphorus compounds, melamine cyanurate, zinc borate, expandable graphite, PTFE, aluminum oxide, hexagonal boron nitride, and a mixture involving at least some of red phosphorus, polybrominated organic compounds, polychlorinated organic compounds, antimony trioxide, metal hydroxides, organic phosphorus compounds, melamine cyanurate, zinc borate, expandable graphite, PTFE, aluminum oxide, and hexagonal boron nitride.

12. The method as recited in claim 9, wherein the method is one of an injection molding method, a thermoforming method, an extrusion method, and an extrusion blow-molding method.

13. The method as recited in claim 9, wherein the at least partial impregnating is carried out in such a way that a solution of the flame retardant material is applied to the material mold and a solvent is subsequently removed.

14. The method as recited in claim 9, wherein in the at least partial impregnating an application of the flame retardant material takes place by at least one of spraying on, brushing on, and injecting.

15. The method as recited in claim 14, wherein the applied flame retardant material includes a solution of the flame retardant material.

16. The method as recited in claim 13, wherein in the at least partial impregnating a removal of the solvent takes place by at least one of drying, heating, applying a vacuum, and blowing the solvent off.

17. The method as recited in claim 9, wherein in the at least partial impregnating the flame retardant material is applied in powder form.
